(19) United States
(12) Patent Application Publication
(10) Pub. No.: US 2006/0036484 A1
(43) Pub. Date: Feb. 16, 2006

(54) Method of providing recyclable, immediately-redeemable award points

(76) Inventor: Michael Voticky, Austin, TX (US)

Correspondence Address: FORTKORT GRETHER + KELTON LLP, 9442 N. Capital of Texas Hwy., Suite 500, AUSTIN, TX, 78759, US

(21) Appl. No.: 10/917,651

(22) Filed: Aug. 13, 2004

(51) Int. Cl. G06Q 30/00

(52) U.S. Cl. 705/14

(57) ABSTRACT

Provided is a method for distribution, allocation, redemption and recycling of bonus points that enables retailers, distributors and wholesalers to offer immediate awards to customers and each other. One implementation employs a medium to store information that can be scanned by a device such as a scan gun, a credit card authentication machine, cash register, swipe telephone, numeric pad or wireless receiver, all of which can be connected to a centralized or distributed data storage via the Internet, telephone lines or wireless communication media. Alternative devices for implementing the system are a coupon, key fob, either wireless or imprinted, or participation information. The card, fob or participation information is scanned or inputted manually or via electronic signal or radio frequency along with the product or service purchased. Point providers determine the number of award points given for a particular product and a user receives instant credit for the points.

### FIELD OF THE INVENTION

This invention pertains generally to a business award bonus point system and, more specifically, to a novel method of immediately providing, awarding, redeeming and recycling award points and reducing the retail market for “grey” and diverted goods.

### BACKGROUND OF THE INVENTION

The first successful rewards/awards program was the Green Stamps program, initiated in the nineteen sixties (1960's), and offered primarily be grocery stores. Customers were given stamps in conjunction with a purchase. The stamps were glued into a book and completed books were submitted in exchange for various products, such as toasters and coffee makers.

Another early rewards program was initiated by Marriott Hotels, which gave points for night stays and dollars spent. Both the Green Stamp and the Marriott reward programs suffered from their complexity and the necessary delay between purchase and redemption. In addition, similar programs were uneconomical for small businesses to implement.

Presently, there exist several award point systems offered by such businesses as credit card companies, airlines and hotels. Typically, current systems provide points or “miles” based upon a dollar value of a purchase or based on mileage/segemnts, number of hotel stays or trips. Occasionally, a current system may award “bonus points” for a particular activity such as booking a flight or purchasing a product via the Internet. In addition, bonus points may occasionally take the form of double or triple points awarded to simulate a particular business activity.

One particular example of a bonus point system is that employed by many airlines. Airlines award points for purchased tickets based upon the flight distance and/or segments flown of the particular ticket. In addition, a distributor, retailer or manufacturer, or “partner,” can purchase airline points to distribute in conjunction with their business offerings. Typically, these bonus points to partners take the form of certificates of five hundred (500) miles and require a minimum purchase of one hundred thousand (100,000) miles. Each five hundred (500) certificate costs, depending upon an airline's policy, ten through twelve fifty dollars ($10-12.50). At this price, providing a certificate to a customer for a small purchase, e.g. twenty-five dollars ($25), is not economically feasible. Thus, many partners allow a customer to accumulate purchases and, when the customer has made, fore example, two hundred fifty to three hundred dollars ($250-300) in purchases, award a certificate to the customer.

Following the awarding of a certificate, the customer must fill out the certificate with personal information; mail a coupon to the certificate provider or other partner and then wait for points to be credited, a process that can take two to four (2-4) weeks. Even a transfer of points form a business such as a credit card company to a certificate provider may take two to five (2-5) days. Obviously, this method is extremely cumbersome and time consuming.

### BRIEF SUMMARY OF THE INVENTION

The claimed subject matter provides a method for distribution, allocation, redemption and recycling of bonus points. The claimed award system enables retailers, distributors and wholesalers to offer both immediate awards and reward redemption to customers and each other. The advantages of the invention, as well as additional inventive features, will be apparent from the description of the invention provided herein.

A reward provider may base an award upon a per product basis, for a particular service, buying a particular product, total dollar amount or some combination of criteria. A particular award program may be industry specific and, to highlight this feature, different award programs are given unique, industry-specific names. For example, in the hair care industry, award points are called “Curls,” in the golf industry, “Tees,” in the restaurant/fast food industry, “Forks,” in the grocery/retail food industry, “Bags,” in the automotive industry, “Tires,” and so on. Of course, these are only a few examples of possible industries and of particular award point names within those industries. For the sake of simplicity, the Detail Description below illustrates the claimed subject matter using only the hair care industry and “Curls” as an example. Although typically administered electronically, the claimed award points may, at times, exist in coupon form.

One implementation of the claimed subject matter employs a card, like a credit or ATM card, to store information that can be scanned by a device such as, but not limited to, a scan gun, a credit card authentication machine or a cash register. The card may be scanned with a swipe telephone, numeric pad or wireless receiver, all of which can be connected to a centralized or distributed data storage via the Internet, telephone lines or wireless communication media. Alternative devices for implementing the system are a key fob, either wireless, imprinted or otherwise scanable, or an account number or email address that can be used to identify a particular participant and program.

When a customer conducts a transaction at a participating business, the card, fob or participation information is scanned or inputted along with the product or service purchased. Of course, the product/service and participation information can be input manually or transmitted via a device such as a wireless transceiver chip. Participation information may be any piece of information that identifies a participant such as, but not limited to, unique code number, an email address or specific personal data. The “instant” award system then, based upon criteria provided or input by business entities participating in the program, determines the number of award points given for the particular product and the customer receives immediate credit for the points. In addition, points may be awarded “up-stream” to previous participants upon completion of a particular transaction. Points can be applied, or redeemed, by participants at any stage of the process. The points may be applied to the current purchase or saved for later use with the result of the transaction, including a figure representing the customer's point balance, printed on a receipt.

In addition to points, cash rewards, in the form of “spiffs,” may be incorporated into the disclosed system. A spiff is an award, typically cash, to a particular sales person, manufacturer's representative or business entity in exchange for the sale of a particular product, service or for completing a sale to a new customer. Fro example, a spiff worth fifty cents ($0.50) may be awarded to a sales person and the sale person's distributor as the result of the sale of a specific type or size of a bottle of shampoo. In addition, if the sales person sells the bottle to a new customer, then a spiff worth five dollars ($5.00) may be awarded to various entities in the sales chain. Like award points, spiffs are typically administered electronically but may, at times, take the form of a payment by cash or check.

The claimed system provides flexibility in compensation with points or more traditional forms of payments. In addition, the claimed system provides the flexibility to trigger an award of spiffs to different levels of participants. For example, when a sale is made at a retail level, spiff awards can be triggered to upstream participants.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE DRAWINGS

FIG. 1 is a block diagram of an exemplary model industry that employs the claimed subject matter.

FIG. 2 is a block diagram showing the flow of product and award points within the model industry of FIG. 1.

FIG. 3 is a table showing an exemplary allocation of award points if a manufacturer has provide award points in conjunction with a sale of a particular product in the product flow of FIG. 2.

FIG. 4 is a table showing an exemplary allocation of award points if, in addition to the manufacturer, a distributor has provide award points in conjunction with a sale of the particular product.

FIG. 5 is a table showing an exemplary allocation of award points if, in addition to the manufacturer and distributor, a retail business provides award points in conjunction with a sale of products and/or services.

FIG. 6 is a table showing an exemplary allocation of award points if a customer or client redeems some award points in conjunction with the sale of a participating retail business' goods or services.

FIG. 7 is an exemplary data object employed to implement the award point system of the claimed subject matter.

FIG. 8 is a flow chart illustrating an exemplary Curls Update process that implements the claimed subject matter.

FIG. 9 is an illustration of the model industry of FIGS. 1 and 2, showing one business entity at each level along with salespeople and distributors.

### DETAILED DESCRIPTION OF THE FIGURES

This disclosure provides a method and system for distribution, allocation, redemption and recycling of bonus points and spiffs that enables retailers, distributors, manufacturers and wholesalers to offer both instant awards and instant award redemption to customers and each other. Throughout the specification abstract and title, the terms “instant” and “immediately” are used interchangeably, both terms implying no significant delay. It should be understood that in any communication and computing system short delays are to be expected. The disclosed subject matter can be applied to many industries but, for the sake of simplicity, the following description is limited to the hair care industry. In addition, there are many different ways to implement the claimed subject matter with respect to communication, storage and processing media. Other aspects, objectives and advantages of the invention will become more apparent from the remainder of the detailed description when taken in conjunction with the accompanying figures.

In addition to award points, cash rewards, called “spiffs,” may be incorporated into the disclosed system. As mentioned above in the Summary, a spiff is an award, typically cash, to a particular sales person or business entity upstream of the particular sales person in exchange for the sale of a product or for completing a sale to a new customer. Although both spiffs and the claimed award points are administered electronically, at times they exist in coupon form, e.g. printed upon a label of a product. Further, at the discretion of the various business entities, award points and spiffs may be interchangeable, i.e. one can be exchanged for the other.

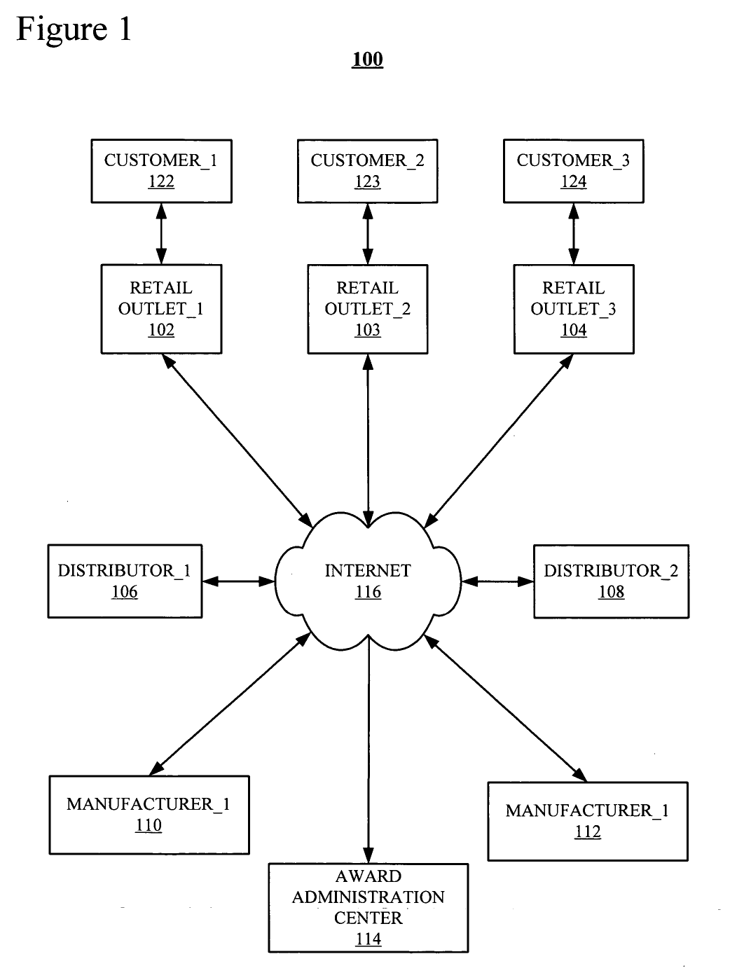

FIG. 1 is a block diagram of an exemplary industry model 100 that employs the claimed subject matter. For the sake of simplicity, industry model 100 is referred to in terms of the hair care industry although many industries could implement the claimed subject matter. Further, in line with the salon example, throughout the Specification, award points will be referred to as “Curls.” Other industry examples include, but are not limited to, the golf, restaurant/fast food, ice cream, hardware, greeting cards, electronics, computer, games, grocery/retail food industry and automotive industries. The system is equally applicable to standard and online business methods.

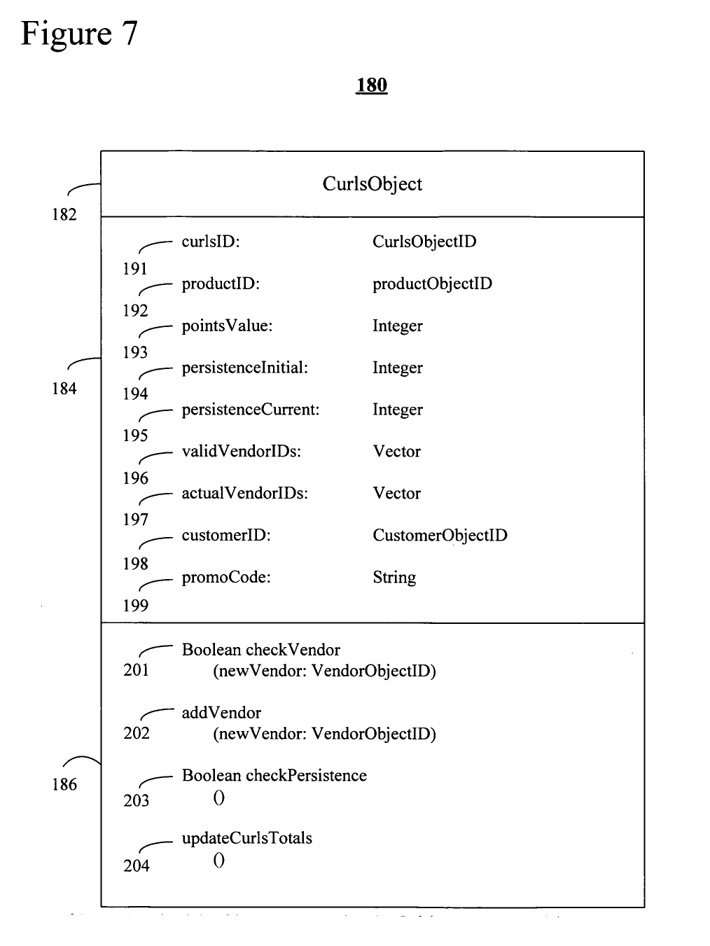

Industry 100 includes exemplary retail outlets, a retail outlet_1 102, a retail outlet_2 103 and a retail outlet_3 104. In this example, retail outlets 102-104 are hair salons that perform services such cutting, styling, coloring, washing hair and performing manicures, pedicures, facials and other services known in the industry as spa related for their customers, or clients, such as a customer_1 122, a customer_2 123 and a customer_3 124, respectively. Of course customers 122, 123 and 124 may do business with more than one retail outlet 102, 103 and 104 and may even purchases products and services from distributors 106 and 108 and manufacturers 110 and 112. Further, retail outlets 102, 103 and 104 may do business with manufacturers 110 and 112. Each of these listed entities can collect Curls during any of these transactions. In addition, Curls can be redeemed at any of the authorized entities, regardless of where a particular Curl was earned or awarded, as long as the particular Curl is not associated with an unexpired promotion of a product or service or some other business entity restriction (see FIG. 7). It should be understood that the system also applies to the award, redemption and exchange of spiffs, which are described above.

Retail outlets 102-104 purchase products, such as shampoo and hair cutting equipment, from manufacturers, such as manufacturer_1 110 and manufacturer_2 112, and distributors, or wholesalers, such as a distributor_1 106 and a distributor_2 108. Products purchased by retail outlets 102-103 from distributors 106 and 108 include products and equipment consumed and used during the performance of the provided services and, further, products offered by retail outlets 102-104 for resale to retail outlets, or clients, 122, 123 and 124.

Distributors 106 and 108 in turn purchase products, equipment, assemble various products and package or repackage supplies from manufacturers such as a manufacturer_1 110 and a manufacturer 2 112. FIG. 1 illustrates communication among retail outlets 102-104, distributors 106 and 108 and manufacturers 110 and 112 taking place online, or over the Internet 116. The Internet 116 is used for illustration purposes only. Of course, any combination of communication media among the various entities is equally applicable. For example, retail out_1 102 may place orders online, via Internet 116, or through salespeople with distributor_1 106 and/or manufacturer_1 110 and yet call in or mail orders to distributor_2 108 via a standard telephone line (not shown), the U.S. Postal Service (not shown) or any other delivery system, respectively.

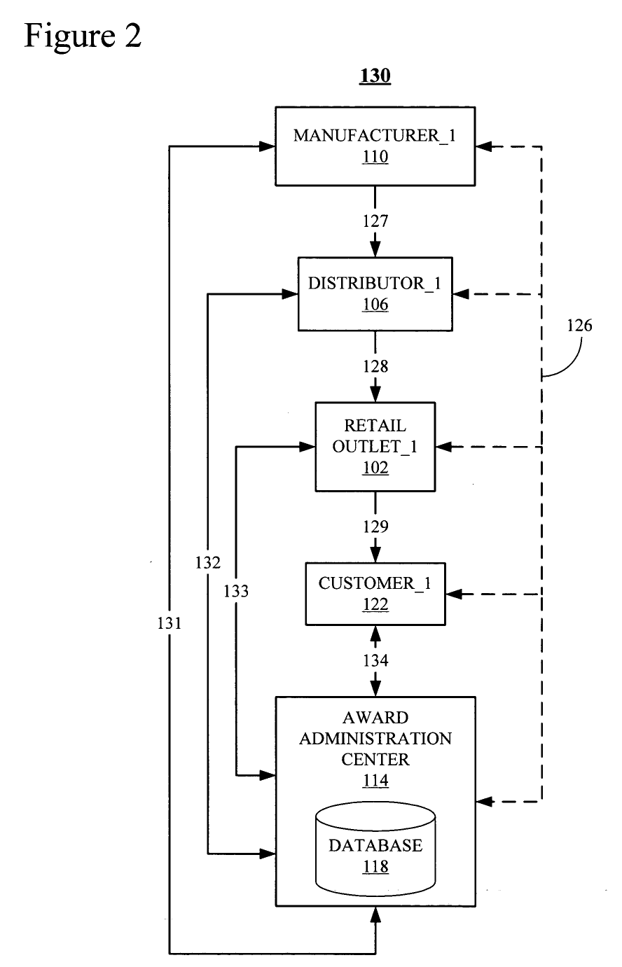

Finally, an award administration center 114 is communicatively coupled to retail outlets 102-104, distributors 106 and 108 and manufacturers 110 and 112. In this example, the communication is handled over Internet 116 but, of course, many possible paths are available, including, but not limited to, direct links, telephone dial-ups, fax, voice messages and wireless connections. Those with skill in the communication and computing arts should recognize many possible configurations and means of communication. The function of award administration center 114 is explained in more detail below in conjunction with FIGS. 2-6.

It should be noted that the concepts of a “manufacturer,’ distributor” and “customer” may not fully describe the many types of business people in a particular business chain. For example, in the hair salon business, many salon owners, such as client_1 122, rent space to stylists, sometimes called booth renters. Typically, retail sales are handled by the salon and booth renters receive a commission. In addition, stylists may earn a salary and/or a commission for the services they render. In the manufacturing and distributing aspects of business, there may be sales people that work either independently or exclusively for a particular client. Further, the claimed subject matter encompasses any sales of products and services and redemption of Curls occurs between business entitles that are not shown directly connected in FIG. 1. For example, manufacturer_1 110 may sell products and redeem Curls directly with retail outlet 102 and/or customer_1 122, perhaps though an Internet website or a third party procesor.

The described award point system provides enough flexibility so that manufacturers, distributors, salon owners and any other type of business people in the business chain can also participate in the system. Any particular type of business person, including salespeople and distributors at all levels, can provide award point incentives to others in the business chain.

Award Administration Center 114 provides access to all users such as users 102-104, 106, 108, 110, 112, and 122-124 via multiple communication mediums as described above. Among the functions users can exercise are checking account balances, transferring and purchasing Curls and/or spiffs for their own use or for the use of others, such as with a gift card. Award Administration Center 114 also supports the generation of various reports for users. For examples, a particular manufacturer can generate a report that displays the number of bottles of X Color shampoo that various distributors/salons have sold in a particular zip code and, by comparing number of bottles sold against the number of Curls redeemed for the particular product, can help identify if a particular product is coming from alternative sources and thus determine whether a distributor/salon is buying grey market products.

Award Administration Center 114 is the original source for Curls. In other words, to award Curls a business entity must either earn them via a transaction with another business entity that is awarding them or purchase Curls from Award Administration Center 114. Award Administration Center 114 may also enable a user with Curls to exchange Curls for other types of award bonus points such as, but not limited to, airline mile points. In an alternative embodiment, a separate communication medium, such as “www.points.com” may be employed for the conversion of Curls to and from other types of award points.

FIG. 2 is a block diagram showing an exemplary flow, or “retail chain,” 130 of product and award points within model industry 100 (FIG. 1). To illustrate the claimed subject matter, an exemplary product, e.g. a bottle of shampoo (not shown), and corresponding award points, i.e. “Curls,” are tracked through the entire distribution chain represented by model 100. In this example, the shampoo and Curls moves from manufacturers 110 to distributors 106, from distributors 106 to retail outlet_1 102, and finally from retail outlet_1 102 to customer_1 122. The flow of product and services is represented by lines 127-129 and the flow of Curls is represented by lines 131-134.

For the sake of this example, the shampoo is a new product, called “X Color Shampoo,” that manufacturers 110 wants to promote in the marketplace. Manufacturer_1 110 charges distributors 106 five dollars ($5) for a bottle of X Color Shampoo; distributors 106 charges retail outlet_1 or salon, 102 ten dollars ($10); and salon 102 charges customer_1, or client, 122 twenty dollars ($20).

To increase market share, manufacturer_1 110 employs Curls to promote sales throughout model 100. Manufacturer_1 110 provides twenty (20) Curls to distributor_1 106 in conjunction with every bottle of X Color shampoo that distributor_1 106 purchases. The allocation of Curls by manufacturer_1 110 is recorded in a database 118 by means of communication between Manufacturer_1 110 and Award Administration Center 114. As described above in conjunction with FIG. 1, there are many possible means of communication between the entities of model 100 and Award Administration Center 114. Processing equipment (not shown) on location at manufacturers 110 is employed to associate the allocated number of Curls, i.e. twenty (20), with the particular product, i.e. X Color Shampoo and to communicate that allocation with Award Administration Center 114.

When Distributor_1 106 receives a quantity of X Color Shampoo from manufacturer_1 110, the product is scanned and, based upon data such as, but not limited to, a universal product code (“UPC”) or a promotional code on the product or on a code printed upon a coupon associated with the product, information corresponding to the corresponding allocation of Curls is retrieved from Award Administration Center 114 via any available and appropriate communication means. Although, typically X Color shampoo is purchased by Distributor_1 106 in case units, for the sake of this example, only a single bottle is tracked through flow 130. At this point, distributors 106 may, depending upon whether or not the Curls are associated with an unexpired product or business entity restriction, allocate the Curls associated with the bottle of X Color shampoo as distributor_1 106 sees fit. In this example, distributors 106 employs processing equipment (not shown) to communicate with Award Administration Center 114 to record that five (5) of the twenty (20) Curls are banked to distributor_1's 106 account and the remaining fifteen (15) Curls are allocated to the particular retail outlet, in this example, salon 102, that purchases the bottle.

In a fashion similar to the transfer of shampoo and Curls from manufacturer_1 110 to distributors 106, when salon 102 receives a quantity of X Color Shampoo from distributors 106, the product is scanned or a code is manually entered and information corresponding to the corresponding allocation of Curls is retrieved from Award Administration Center 114 via appropriate communication means. At this point, salon 102 may, depending upon whether or not the Curls are associated with an unexpired product or business entity restriction, allocate the Curls associated with the bottle of X Color shampoo as salon 102 sees fit. In this example, salon 102 employs processing equipment to communicate with Award Administration Center 114 to record that five (5) of the remaining fifteen (15) Curls are banked to salon's 102 account and the remaining ten (10) Curls are allocated to the particular customer, in this example, customer_1 122, who ultimately purchases the bottle of X Color shampoo.

When customer_1 122 purchases the bottle of X Color shampoo, the bottle is scanned, participation information, such as, but not limited to a unique code number, an email address or specific personal data, is either entered manually or scanned from an identification card carried by customer_1 122. The identity of the customer is verified by any available or yet to be developed means. For example, if the customer manually enters a customer number, then a confirmation code or password may also be required. Methods of verifying an identification card include, but are not limited to, signature verification, thumb/finger print verification, personal action code, eye scan or, possibly in the future, instant DNA verification.

Both the product information and the customer's identity information are communicated to Award Administration Center 114 and stored in database 118. Award Administration Center 114 correlates the bottle with the appropriate number of Curls, credits the account of customer_1 122 and communicates relevant information back to the register, or whatever other type of checkout equipment, at salon 102. Salon 102 prints a receipt for customer_1 122 that includes the number of Curls associated with the purchase of the shampoo and the balance of Curls currently on account for customer_1 122. In this manner, customer_1 122 can track their Curl account. In addition, such features as email or other type of notification system can be incorporated into the award system for the benefit of all participants.

A dashed line 126 represents the flow of Curls through business chain 100. Because of the unique structure of the current system, Curls can be instantly awarded and redeemed by any of the business entities to and from any of the other business entities. In other words, Curls can be allocated by manufacturer_1 110 such that any entity 106, 102 or 122 can be awarded the Curls. Further, manufacturer_1 110 can specify which entity 106, 102 or 122 is eligible to redeem a particular batch of Curls.

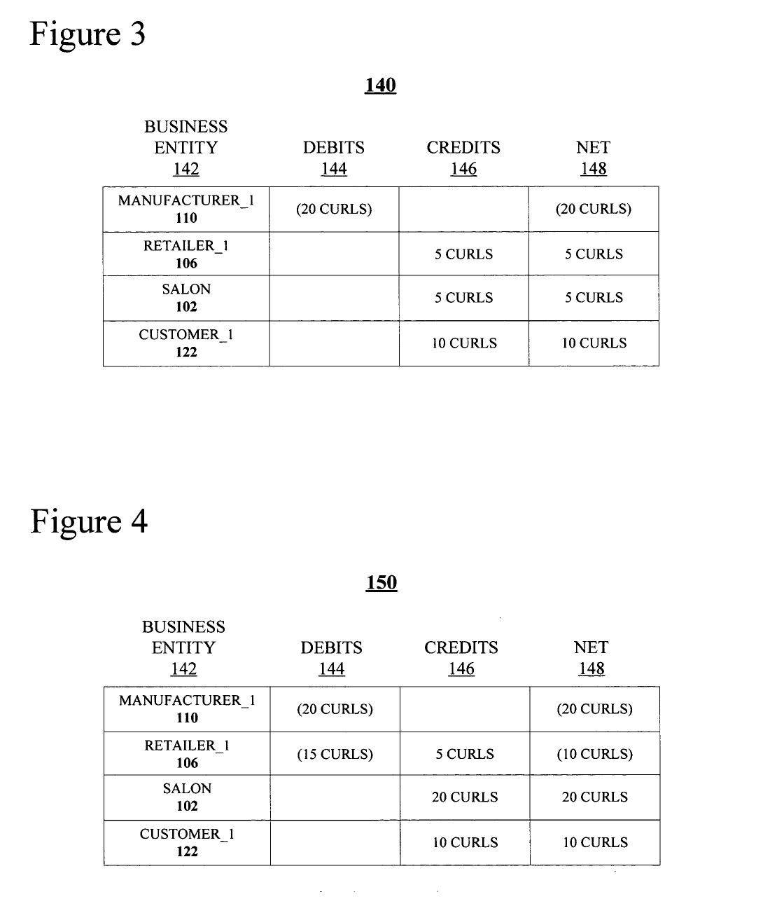

FIG. 3 is a table 140 showing an exemplary allocation of Curls as a bottle of X Color shampoo has moves through product flow 130 of FIG. 2. The information contained in the tables of FIGS. 3-7 are stored in a memory associated with Award Administration Center 114 (FIGS. 1 and 2).

Table 140 includes a “Business Entity” column 142, a “Debits” column 144, a “Credits” column 146 and a “Net” column 148. Business Entity column 142 represents the particular participants used in this example, i.e. manufacturer_1 110, distributor_1 106, salon 120 and customer_1 122. Debits column 144 represents a number of Curls that are provided by a particular business entity. Credits column 146 represents the number of Curls that a particular business entity receives on a particular transaction. Net column 148 represents a number of Curls a particular business entity has in an account at any particular time and is equal to the sum of the corresponding values in Debit column 144 and Credit column 146.

As explained above in conjunction with FIG. 2, at this point in flow 120 (FIG. 2), manufacturer_1 110 has allocated twenty (20) Curls per bottle for Color shampoo as a promotional device. Therefore, a negative twenty (20) Curls is listed in column 144 in the row represented by manufacturer_1 110. Using standard accounting notation, a negative number is represented by including parentheses, around the figure, i.e. “(20 Curls).” In the absence of any other transactions involving other bottles, Net column 148 also lists negative twenty (20) Curls for manufacturer_1 110.

Once distributor_1 106 has purchased the bottle, distributor-1 106 keeps five (5) Curls for their own purposes, giving distributor_1 106 balances of five (5) Curls in both Credit column 146 and Net column 148. It should be noted that distributor_1 106 can allocate the twenty (20) Curls any way they see fit. For example, they may offer Curls in conjunction with the sale of X Color shampoo or in conjunction with any other of their products. In this example, fifteen (15) of distributor_1's 106 Curls are still associated with the sale of X Color shampoo.

Likewise, once salon 102 has purchased the bottle, salon 102 keeps five (5) Curls for their own purposes, giving salon 102 balances of five (5) Curls in both Credit column 146 and Net column 148. Finally, customer_1 122 purchases a bottle of X Color shampoo, customer_1 122 is awarded the remaining ten (10) Curls, giving customer_1 122 balances of ten (10) Curls in both Credit column 146 and Net column 148.

It should be noted that the sum of the values stored in Debits column 144 is a negative of the sum of the values stored in Credits column 146 and that the sum of the values in Net column 148 is equal to zero (0).

FIG. 4 is a table 150 showing the allocation of Curls if, in addition to manufacturer_1 110, distributor 1 106 provides Curls in conjunction with a sale of a bottle of X Color shampoo. The figures in the rows representing manufacturer_1 110 and customer_1 122 remain the same as in table 140 (FIG. 3). In the row representing distributor_1 106, Debits column 144 now has a value of negative fifteen (15) Curls, representing distributor_1's contribution, and Net column 148 has a value of negative ten (10) Curls. Distributor_1 106 still has the value of five (5) Curls in Credits column 146, which were the Curls distributor_1 106 received from manufacturer_1 110. Salon 102 now has a value in Credit column 146 and Net column 148 of twenty (20) Curls.

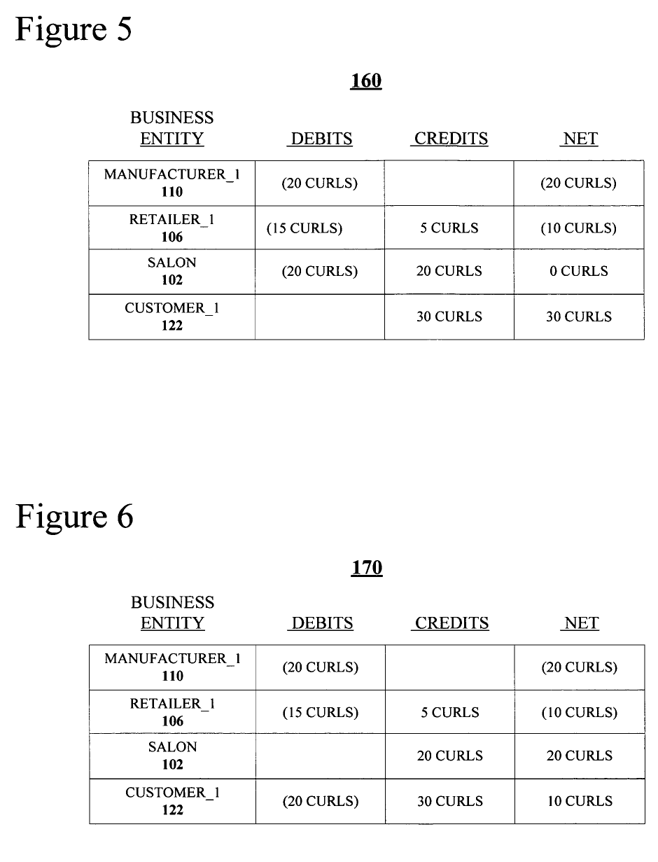

FIG. 5 is a table 160 showing the allocation of Curls if, in addition to manufacturer_1 110 and distributor_1 106, salon 102 provides Curls in conjunction with a sale of a bottle of X Color shampoo. The figures in the rows representing manufacturer_1 110 and distributor_1 106 remain the same as in table 150 (FIG. 4). In the row representing salon 102, Debits column 144 now has a value of negative twenty (20) Curls, representing salon's 102 contribution, and Net column 148 has a value of zero (0) Curls. Salon 102 still has the value of twenty (20) Curls in Credits column 146, which were the Curls salon 102 received from manufacturer_1 110 and distributor_1 106. Customer_1 122 now has a value in Credit column 146 and Net column 148 of thirty (30) Curls, which customer_1 122 may use on whatever products and services that salon 102 offers in exchange for Curls.

FIG. 6 is a table 170 showing the allocation of Curls if customer_1 122 redeems twenty (20) Curls on some combination of products and services at salon 102. The values in rows corresponding to manufacturer_1 110 and distributor_1 106 remain the same as in FIG. 5. Customer_1 122 receives a value in Debit column 144 of negative twenty (20) Curls, which takes the value of the corresponding Net column 148 row to ten (10) Curls, which may be saved or redeemed for additional products and/or services. In addition, The value of Debit column 144 corresponding to the row of salon 102 is adjusted to a value of zero (0) Curls to reflect the fact that salon 102 has redeemed twenty (20) Curls and the value of Net Column 148 for salon 102 is also modified to twenty (20) Curls to reflect this transaction.

The balance of twenty (20) Curls in Net column 148 corresponding to the row of salon 102 may be used by salon 102 to offer additional promotions or used to purchase products and/or equipment from distributor_1 106 or manufacturer_1 110. One example of a method of providing participants in model 100 (FIG. 1) information relating to Curls and associated products and/or services if to publish an Internet 116 (FIG. 1) online catalog can be on the goods and services provided by the participants and associated with Curls.

FIG. 7 is an exemplary CurlsObject (CO) memory object 180 employed to implement the award point system of the claimed subject matter. CO memory object 180 includes a title section 182, which merely states the name of CO object 180, an attribute section 184, which contains memory elements, or attributes, associated with CO memory object 180, and a method section 186, which includes functions, or methods, that are executed in conjunction with CO memory object 180.

Attribute section 184 includes a “curlsID” attribute 191, a “productID” attribute 192, a “pointsValue” attribute 193, a “persistenceInitial” attribute 194, a “persistenceCurrent” attribute 195, a “validVendorsIDs” attribute 196, an “actualVendorIDs” attribute 197, a “customerID” attribute 198 and a promoCode attribute 199. Instantiations of object 180 are stored in memory (not shown) of Award Administration Center 114 (FIGS. 1 and 2).

CurlsID attribute 191 is a variable of type CurlsObjectID that contains a reference to a particular instance of object 190. Each instance of object 190 has a unique value for attribute 191 that allows each instance to be uniquely identified. ProductID attribute 192 is a variable of type ProductObjectID that stores information to identify a particular product or service, e.g. X Color shampoo, associated with a particular instantiation of object 180.

PointsValue attribute 193 is a variable of type Integer that stores a value corresponding to the number of Curls corresponding to the particular instantiation of CO memory object 180. For example, if manufacturer_1 110 (FIGS. 1 and 2). desires to place a bonus value of twenty (20) Curls on a bottle of X Color shampoo, then manufacturer_1 110 communicates with Award Administration 114 to instantiate an instance of object 180 that includes a value for productID attribute 192 corresponding to X Color shampoo and a value for pointsValue attribute 193 equal to twenty (20). In other words, Curls are typically awarded in blocks that can vary from a single Curl hundreds of Curls or more, depending upon the value of the product or service to which they are associated.

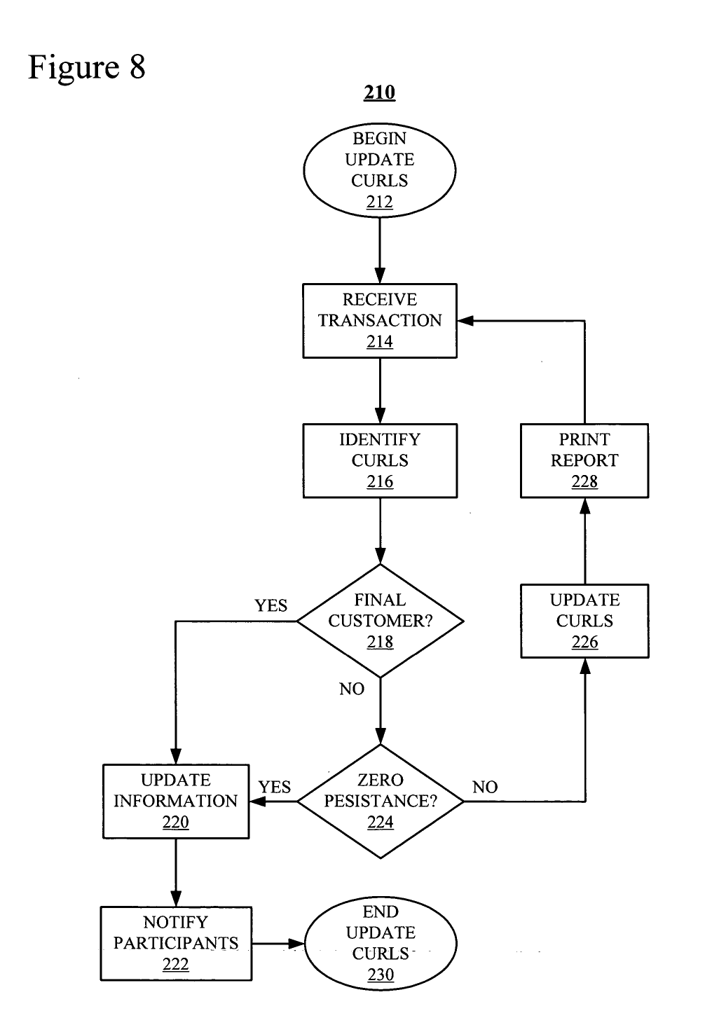

PersistenceInitial attribute 194 is a variable of type Integer that stores a value that indicates a number of transactions, or steps in retail chain 130 (FIG. 2)., that must be traversed by the particular product indicated by attribute 192 before the corresponding Curls may be separated from the product. For example, if manufacturer_1 110 intends for the corresponding Curls to be passed to the ultimate customer, such as customer_1 122, then, at the time of instantiation, manufacturer_1 110 would set the value of attribute 194 equal to ‘3’. PersistenceCurrent attribute 195 is a variable of type Integer that stores a value that indicates the remaining levels of retail chain 130 that must be traversed by the particular bottle of X Color Shampoo before the corresponding instantiation of object 180 may be separated from X Color Shampoo, i.e. assigned to whatever product or service the holder of object 180 desires. One implementation of the claimed subject matter with respect to attributes 194 and 195 is described below in conjunction with FIG. 8.

ValidVendorIDs attribute 196 is a variable of type Vector that stores a list of VendorObjectID memory objects (not shown). Each vendorMemoryObjectID stored in attribute 196 corresponds to a particular vendor in retail chain 130. Using attribute 196, the originator of a particular CO memory object 180, such as manufacturer_1 110, can specify, and thereby control, which particular vendors, such as distributor_1 106 (FIGS. 1 and 2). and salon 102 (FIGS. 1 and 2), are authorized to distribute the corresponding Curls. ActualVendorIDs attribute 197 stores vendorMemoryObjectIDs corresponding to the particular vendors in retail chain 130 that actually handle the CO memory object 180, whether tied to a particular product or not.

CustomerID attribute 198 is a variable of type CustomerObjectID (not shown) that corresponds to a memory object that stores information on a particular customer, such as customer_1 122. By using attribute 198, businesses in retail chain 130 can collect and analyze information relating to the ultimate user of their products. In this manner, customerID attribute 198 enables a business to gather information such as, but not limited to, sex and age about the users of their products and services. Reports based upon customerID attribute 198 can be periodically produced to provide all businesses in the commercial chain with a profile of their customer base.

PromoCode attribute 199 is a variable of type String that enables CO memory objects to be grouped according to other attributes such as productID attribute 192 and pointsValue attribute 193. For example, manufacturer_1 110 can print on a bottle of X Color Shampoo or on a coupon associated with the promotion, product or service a promotional code corresponding to a specific promoCode 199 that says, “A bottle of X Color shampoo is worth 20 Curls: Refer to Promo Code X999.” PromoCode attribute 199 not only enables a supplier or buyer of the bottle of X Color shampoo to more easily input information about a transfer of Curls in the absence or in lieu of a scanning device, but also, by printing such information on the bottle, manufacturer_1 110 is able to deter out-of-channel sales because a buyer of the bottle is likely to ask an unauthorized seller to redeem the Curls listed on the bottle. A consumer who is denied the redemption or award of points by an unauthorized vendor will also likely be discouraged from future buying of other gray market products from that vendor.

Method section 186 of object 180 includes a “checkVendor” method 201, an “addVendor” method 202, an “checkpersistence” method 203 and a updateCurlsTotal method 204, each of which are called at various points in a Curls Update process 210, described below in conjunction with FIG. 8.

CheckVendor method 201 is called with one (1) parameter, “newVendor” of type VendorObjectID, which corresponds to a particular vendor that is being verified as a vendor approved to redeem the Curls associated with CO memory object 180. CheckVendor method 201 returns a Boolean value, with the value ‘0’ indicating that the vendor represented by parameter NewVendor is not included in validVendorIDs vector 196. If checkVendor method 201 returns a value of ‘1’, then the vendor is in validVendorIDs vector 196, and is thus an authorized vendor.

AddVendor method 202 is called with one (1) parameter, “newVendor” of type VendorObjectID, which corresponds to a particular vendor that is being added as a vendor approved to redeem the Curls associated with CO memory object 180. AddVendor method 202 does not return a value. Method 202 is typically called by the business entity, such as manufacturers 110, that creates the particular instantiation of object 180.

CheckPersistence method 203 is called without parameters and returns a Boolean value, with the value ‘0’ indicating that persistenceCurrent attribute 195 has a positive value and thus CO object 180 is still tied to the product represented by productID attribute 192. If checkPersistence method 203 returns a value of ‘1’, then object 180 is not tied to the product represented by productID attribute 192 and may be exchanged for any product or service.

Finally, updateTotals method 204 is called without parameters and does not return a value. Typically, updateTotals method 204 is called once checkpersistence method has returned a value of ‘1’ indicating that corresponding CO object 180 is no longer tied to the product represented by productID 192. Method 204 updates information stored in memory (not shown) at Award Administration Center 114 corresponding to Curl balances associated with the various business entities that have redeemed CO object 180. In other words, Curl totals for the various business entities are not updated until persistenceCurrent attribute 195 indicates that CO memory object 180 is no longer tied to the product represented by productID 192.

It should be noted that there are many additional attributes and methods that may be implemented in conjunction with the claimed subject matter. For example, attribute section 184 of CO memory object 180 can include a vector that indicates the particular products associated with object 180 throughout retail chain 130 once the persistence feature expires and object 180 is no longer tied to a particular product such as X Color shampoo. Method section 186 of CO memory object 180 can include an addCustomer method that initiates a graphical user interface (GUI) for entering information relating to a new customer who chooses to participate in the Curls award points system. In other words, CO object 180 is only an example of a memory objects that may be used to implement the claimed subject matter. Other memory objects with fewer, more and/or different attributes and methods may be employed. One with skill in the computing arts should appreciate there are many ways to implement the functionality and data storage requirements of the claimed subject matter.

FIG. 8 is a flow chart illustrating an exemplary Curls Update process 210 that implements a portion of the claimed subject matter, specifically the portion that credits and debits user accounts in a transaction involving a particular CO memory object 180 (FIG. 7). In this example, process 210 is a server process (not shown) executing at Award Administration Center 114 (FIGS. 1 and 2). Process 210 starts in a “Begin Update Curls” block 212, which is initiated by a user such as retail outlets 102-104, distributors 106 or 108, manufacturers 110 or 112, and possibly even customers 122-124. As mentioned above, users 102-104, 106, 108, 110, 112 and 122-124 may execute process 210 at Award Administration Center 114 via communication mediums such as, but not limited to, an Internet connection, a dial-up connection, or with operator or administrator assistance. Process 210 may also be initiated automatically by a sales terminal at a user's business location.

From block 212, control proceeds to a “Receive Transaction” block 214 during which process 210 receives a Curls transaction from the user. Once a transaction is received, control proceeds to an “Identify Curls” block 216 during which process 210 employs information transmitted with the transaction received in block 214 to identify a particular instantiation of a CO memory object 180 corresponding to the transaction.

Control then proceeds to a “Final Customer?” block 218 during which process 210 determines whether or not the transaction is the redemption of Curls by a client such as client_1 122, i.e. a transaction by the final consumer of the product rather than by an intermediate user such as distributor_1 106. Of course, in some transactions, a user who is typically an intermediate user may be the final consumer.

If the transaction has been initiated by the final consumer, control proceeds to an “Update Information” block 220 during which process 210 either scans or otherwise inputs a user ID number corresponding to, in this case, client_1 122 and fills in customerID attribute 198 (FIG. 7) of the OC memory object identified in block 216. If customer information is unavailable, then process 210 may generate a GUI that enables the business conducting the transaction to input the information. ActualVendornDs attribute 197 is also updated and accounts associated with all the vendors stored in attribute 197 are updated to reflect the transaction, as described above in conjunction with FIGS. 3-6. Once a Curl is being processed in block 220, the Curl has been disassociated from a specific product and the account balances of the various business entities that have handled the Curls are then updated. In other words, the expiration of a persistence value, triggers an update in the Curl balance of the accounts of the upstream entities. Control then proceeds to a “Notify Participants” block 222 during which process 210 notifies each affected user, via email or other suitable transmission medium, of the current status of their accounts, including the current balance of Curls. Control then proceeds to an “End Update Curls” block 230 in which process 210 is complete.

If, in block 218, process 210 determines that the transaction has not been initiated by a final consumer, then control proceeds to a “Zero Persistence?” block 224 during which process 210 determines whether or not the persistenceCurrent attribute 195 (FIG. 7) has reached a value of zero (0), indicating that the corresponding Curls are not currently tied to a particular product or service. In this case, control proceeds to Update Information block 220 and control proceeds as described above. If persistenceCurrent attribute 195 is not equal ‘0’, then control proceeds to an “Update Curls” block 226 during which actualVendorIDs attribute 197 of the CO memory object 180 identified in block 216 is updated to reflect the identity of the user processing the transaction received in block 214. Control then proceeds to a “Print Report” block 228 during which the participant receives a transaction report show the current transaction and the balance of Curls in their account. Control then returns to Receive Transaction block 214 during which process 210 waits for another transaction to process.

As mentioned above, process 210 represents the processing of a particular CO memory object 210. Those with skill in the computing arts should recognize that process 210 is a virtual process that may actually be executed by multiple instantiations of a number of processes working together. For example, Award Administration Center 114 may spawn separate processes to execute potions of the described functionality each time a transaction is received in Receive Transaction block 214.

Briefly, the claimed subject matter provides a novel system for purchasing, rewarding, recycling and redeeming award points that enables users at every level of the business chain the opportunity to participate. Another feature of the described system is that the grey market and other unauthorized sales of products are discouraged by informing consumers. In other words, consumers that are aware of potential award points for a particular product will be less inclined to purchase a product or service from an unauthorized distribution channel if they must forgo the corresponding bonus points.

Although illustrated with respect to a single customer, retail outlet, distributor and manufacturer, the Curls system can be employed across multiple business entities and with respect to multiple products and services. Curls do not have to be redeemed by a business entity that awards them but, rather, can be redeemed by any business that is a participant in the Curls system. Each business may redeem, recycle, assign to a different product or service or simply pass along Curls that have accrued in their respective account at the Award Administration Center 114.

In addition, if a holder of Curls does not have enough Curls to execute a particular transaction, then the Curl holder may purchase additional Curls from Award Administration Center 114 or from any business entity in the commercial chain.

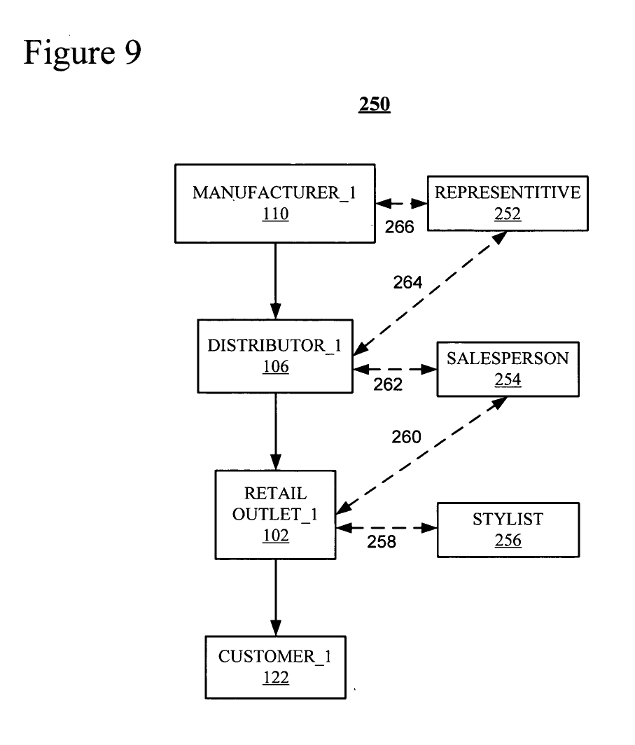

FIG. 9 is an illustration 250 of the model industry 100 of FIGS. 1 and 2, showing one business entity at each level, specifically manufacturer_1 110, distributer_1 106, retail outlet_1 102 and customer_1 122. Also illustrated are a stylist 256, who works in conjunction with retail outlet_1 122, a salesperson 245, who works in conjunction with distributer_1 106, and a representative, or “sales rep,” 252, who works in conjunction with manufacturer_1110. In addition to stylist 256 and representative 252, other types of sales people at the various levels in business chain 100 are also able to participate in the claimed reward techniques. Those with skill in the business community should understand the various roles played and relationships among the various entities of FIG. 9.

Dotted lines represent some of the potential movement of Curls among the various business entities of FIG. 9, in addition to those described above. For example, if customer_1 122 buys a bottle of X Color shampoo from retail outlet_1 102 and receives a 20 Curl credit, retail outlet_1 102 may then award Curls to stylist 256 as well, as represented by a doted line 258. Of course, like any participant in the system, stylist 256 may redeem the earned Curls or award them to another participant as a gift or award. For example, stylist 256 may have a half hour of unassigned time after customer_1's 122 haircut and so offers Curls to customer_1 122 if customer_1 122 is willing to purchase a hair braiding.

In a similar fashion, when retail outlet_1 102 buys a box of X Color shampoo, a salesperson in the specific chain at any level, such as salesperson 254, may receive Curls from distributor_1 106 as a reward for making the sale, as represented by a dotted line 262. Salesperson 254 may redeem the accrued Curls or pass them on to a client to generate more sales. When distributor_1 106, buys a pallet of X Color shampoo from manufacturer_1 110, manufacturer_1 110 awards representative 252 a certain number of Curls. Of course, it should be noted that the same transaction that triggers the award of Curls at multiple levels up the retail chain may also generate the award of spiffs at multiple levels.

Dotted lines 260 and 264 represent Curls that have been triggered one more level up the business chain than those awards represented by lines 258, 262 and 266. Lines 258, 260, 262, 264 and 266 are only examples of the many ways that awards can be triggered by any particular sale. Every time a Curl associated product or service is scanned or otherwise registered, Award Administration Center 114 (FIGS. 1 and 2) automatically adjusts the balances of the appropriate business entities based upon an award plan correlated with the awarded points. It should be noted that, once Curls are initiated, any particular Curl may circulate, or “recycle,” for an unlimited amount of time within the business system. In other words, unlike prior art award programs, Curls are not necessarily redeemed by Award Administration Center 114, from which they originally sold, but rather may stay in retail chain 100 re-circulating for an unlimited amount of time.

In the context of this document, a “memory,” “recording medium” and “data store” can be any means that contains, stores, communicates, propagates, or transports the program and/or data for use by or in conjunction with an instruction execution system, apparatus or device. Memory, recording medium and data store can be, but are not limited to, an electronic, magnetic, optical, electromagnetic, infrared or semiconductor system, apparatus or device. Memory, recording medium and data store also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A bonus point award system, comprising:
a plurality of bonus points, each point of the plurality of points assignable to one or more business offerings of a plurality of business offerings,
wherein a point acquired by any particular participant of a plurality of participants in a multi-level business chain is immediately awardable, redeemable and recyclable by the particular participant.

2. The award point system of claim 1, wherein a business offering of the plurality of business offerings comprise a service.

3. The award point system of claim 1, wherein a business offering of the plurality of business offerings is a product.

4. The award point system of claim 1, further comprising a plurality of promotional codes, each promotional code associated with a subset of the plurality of points, wherein each promotional code corresponds to an incentive to buy a particular business offering.

5. The award system of claim 1, each bonus point of the plurality of business points comprising a persistence value, the persistence value comprising a predefined number of transactions associated with the business point,
wherein once the predefined number of transactions have been executed the corresponding bonus point becomes disassociated from the plurality of business offerings to which it is assigned.

6. The award system of claim 1, wherein each point can circulate in the business chain for an indefinite period of time.

7. The award system of claim 1, wherein a participant in the multiple-level business chain may set redemption criteria with respect to business products offered by the participant.

8. The award system of claim 1, wherein a participant in the multiple-level business chain may set award criteria with respect to business products offered by the participant.

9. The award system of claim 1, further comprising an access system whereby each participant can quickly determine a status of an account corresponding to the particular participant.

10. The award system of claim 9, wherein the access system provides the particular participant with reports on sales and award point redemption of other, sales-related participants in the business chain such that the particular participant can determine whether or not any of the sales-related participants are acquiring the one or more business offerings from outside the business chain.

11. The award system of claim 1, wherein an award of business points to a participant triggers an award of business points to another participant.

12. The award system of claim 1, further comprising:
a plurality of spiffs, each spiff of the plurality of spiffs assignable to one or more business offerings of a plurality of business offerings,
wherein a spiff acquired by any particular participant of a plurality of participants in a multi-level business chain is immediately awardable, redeemable and recyclable by the particular participant; and
wherein an award of spiffs to a participant triggers an award of spiffs to another participant.

13. The award system of claim 1, further comprising;
logic for compiling consumer data corresponding to participants;
logic for correlating the consumer data to the one or more business offerings; and
logic for generating a consumer report based upon the correlation between the consumer data and the one or more business offerings.

14. A method of transaction for bonus points, comprising:
assigning a plurality of bonus points to one or more business offerings of a plurality of business offerings,
wherein each point of the plurality of bonus points acquired by any particular participant of a plurality of participants in a multi-level business chain is immediately awardable, redeemable and recyclable by the particular participant.

15. The method of claim 14, wherein a business offering of the plurality of business offerings comprise a service.

16. The method of claim 14, wherein a business offering of the plurality of business offerings is a product.

17. The method of claim 14, further comprising associating a promotional code as an incentive to buy a particular business offering.

18. The method of claim 14, further comprising:
assigning a bonus point of the plurality of business points a persistence value,
wherein the persistence value defines a predefined number of transactions associated with the business point, and
disassociating the bonus point from the plurality of business offerings to which it is assigned once the predefined number of transactions have been executed

19. The method of claim 14, wherein each point can circulate in the business chain for an indefinite period of time.

20. The method of claim 14, wherein a participant in the multiple-level business chain may set redemption criteria with respect to business products offered by the participant.

21. The method of claim 14, wherein a participant in the multiple-level business chain may set award criteria with respect to business products offered by the participant.

22. The method of claim 14, further comprising providing each participant access whereby each participant can quickly determine a status of an account corresponding to the particular participant.

23. The method of claim 22, wherein the access system provides the particular participant with reports on sales and award point redemption of other, sales-related participants in the business chain such that the particular participant can determine whether or not any of the sales-related participants are acquiring the one or more business offerings from outside the business chain.

24. The method of claim 14, further comprising awarding business points to a second participant when an award of business points is awarded to a first participant.

25. The method of claim 14, further comprising:
assigning a plurality of spiffs to one or more business offerings of the plurality of business offerings,
wherein a spiff acquired by any particular participant of a plurality of participants in a multi-level business chain is immediately awardable, redeemable in business points and recyclable by the particular participant; and
wherein a participant of the plurality of participants who awards the spiff may elect to redeem the spiff by means of cash, a credit to a credit or debit card or a direct deposit to an account of the particular participant who acquired the spiff; and
awarding spiffs to a second participant when an award of spiffs is made to a first participant.

26. The method of claim 14, further comprising;
compiling consumer data corresponding to participants;
correlating the consumer data to the one or more business offerings; and
generating a consumer report based upon the correlation between the consumer data and the one or more business offerings.

27. A computer programming product, comprising:
a memory;
logic, stored on the memory, for assigning a plurality of bonus points to one or more business offerings of a plurality of business offerings,
wherein each point of the plurality of bonus points acquired by any particular participant of a plurality of participants in a multi-level business chain is immediately awardable, redeemable and recyclable by the particular participant.

28. The computer programming product of claim 27, wherein a business offering of the plurality of business offerings comprise a service.

29. The computer programming product of claim 27, wherein a business offering of the plurality of business offerings is a product.

30. The computer programming product of claim 27, further comprising logic, stored on the memory, for associating a promotional to an incentive to buy a particular business offering.

31. The computer programming product of claim 27, further comprising:
logic, stored on the memory, for assigning a bonus point of the plurality of business points a persistence value,
wherein the persistence value defines a predefined number of transactions associated with the business point, and
logic, stored on the memory, for disassociating the bonus point from the plurality of business offerings to which it is assigned once the predefined number of transactions have been executed

32. The computer programming product of claim 27, wherein each point can circulate in the business chain for an indefinite period of time.

33. The computer programming product of claim 27, wherein a participant in the multiple-level business chain may set redemption criteria with respect to business products offered by the participant.

34. The computer programming product of claim 27, wherein a participant in the multiple-level business chain may set award criteria with respect to business products offered by the participant.

35. The computer programming product of claim 27, further comprising logic, stored on the memory, for providing each participant access such that each participant can quickly determine a status of an account corresponding to the particular participant.

36. The computer programming product of claim 35, wherein the access system provides the particular participant with reports on sales and award point redemption of other, sales-related participants in the business chain such that the particular participant can determine whether or not any of the sales-related participants are acquiring the one or more business offerings from outside the business chain.

37. The computer programming product of claim 27, further comprising logic, stored on the memory, for awarding business points to a second participant when an award of business points is awarded to a first participant.

38. The computer programming product of claim 27, further comprising:
logic, stored on the memory, for assigning a plurality of spiffs to one or more business offerings of the plurality of business offerings,
wherein a spiff acquired by any particular participant of a plurality of participants in a multi-level business chain is immediately awardable, redeemable and recyclable by the particular participant; and
logic, stored on the memory, for awarding spiffs to a second participant when an award of spiffs is made to a first participant.

39. The computer programming product of claim 27, further comprising;
logic, stored on the memory, for compiling consumer data corresponding to participants;
logic, stored on the memory, for correlating the consumer data to the one or more business offerings; and
logic, stored on the memory, for generating a consumer report based upon the correlation between the consumer data and the one or more business offerings.
